(19) United States
(12) Patent Application Publication
(10) Pub. No.: US 2003/0059192 A1
(43) Pub. Date: Mar. 27, 2003

(54) Apparatus and method for holding coilable elongated product

(76) Inventor: Christopher P. Johnson, Elmira Heights, NY (US)

Correspondence Address: CORNING INCORPORATED, SP-TI-3-1, CORNING, NY, 14831

(21) Appl. No.: 09/960,561

(22) Filed: Sep. 21, 2001

(51) Int. Cl. G02B 6/00; B65H 75/22

(52) U.S. Cl. 385/135; 242/570

(57) ABSTRACT

The present invention includes a collapsible reel which allows loose coils of coilable elongated product, such as optical fiber, to be removed therefrom. The collapsible reel includes a resilient discontinuous annulus and at least one removable endcap.

The present invention also includes a tray and tray assembly for holding, storing, and/or transporting coilable elongated product, such as optical fiber, in a state of reduced tension.

The present invention includes a method for measuring an optical property of an optical waveguide fiber which includes winding the optical waveguide fiber into a plurality of loops on a collapsible reel, collapsing the collapsible reel, measuring the optical property, and expanding the collapsible reel.

### BACKGROUND OF THE INVENTION

1. Field of the Invention

The present invention relates generally to an apparatus for holding coilable elongated product, and particularly to reels and trays for holding coilable elongated product such as optical fiber.

2. Technical Background

Coilable elongated product made of flexible or filamentary or ribbonlike material is typically wound on spools or reels, often under tension. The spool is utilized in winding up or paying out the elongated product, and product may be transported in a coiled or wound form on the spool. Elongated product may be, for example, fiber, cable, line, thread, rope, ribbon, wire, or tape.

Optical waveguide fiber is typically wound onto a spool during the manufacture thereof. The coils of optical fiber are handled and transported with the fiber under tension, such as on shipping spools or reels. One typical example of a shipping spool has a center cylindrical section around which the optical fiber is drawn, the cylindrical section having a diameter of about 8 inches. Frequently, it is desirable to measure one or more optical characteristics of an optical fiber, such as attenuation or bandwidth. Multimode fiber is particularly sensitive to bending. However, the bend characteristics, such as microbending, of optical fiber wound under tension likely would not be representative of the microbend characteristic of the same fiber when deployed in the field in a relatively uncoiled or relatively untensioned state. Therefore, the optical characteristics of an optical fiber are measured by first unwinding a length of the fiber (as much as about 25 km) from the shipping spool, winding the fiber under a lesser degree of tension on a measurement spool of larger diameter, such as a diameter of 14 inches, and then the two leads of the optical fiber are connected to a measurement device. The larger diameter of the measurement spool is intended to better reflect a planned deployed state of the optical fiber which is relatively free of externally induced microbend losses.

Typically, for an optical fiber which is mounted on a shipping spool under tension, measurements of the optical characteristics of the optical fiber are carried out at the location of an unwinding and winding apparatus so that the optical fiber can be unwound from its relatively higher tensioned state on the shipping spool and rewound in a relatively lower tensioned state prior to measurment. That is, the measurement device and the unwinding/winding apparatus are situated at the same location.

### SUMMARY OF THE INVENTION

In one aspect, the present invention relates to a collapsible reel comprising: a resilient discontinuous annulus having an outer circumferential surface and an inner circumferential surface generally disposed about a longitudinal axis, first and second longitudinally spaced apart ends, and first and second edges defining a generally longitudinal discontinuity, wherein the inner and outer circumferential surfaces and ends are capable of being symmetrically disposed about the longitudinal axis when the annulus is in an expanded state, and wherein the first and second edges form a gap at the discontinuity when the annulus is in the expanded state; and an endcap removably attached to the first end of the annulus, the endcap having a transverse flange adjacent the first end of the annulus, the flange radially extending past the outer circumferential surface of the annulus, and a shoulder disposed under the inner circumferential surface of the annulus, wherein the shoulder is adapted to maintain the annulus in the expanded state when engaged therewith, wherein at least a portion of the annulus contracts when the endcap is removed therefrom, thereby reducing at least a portion of the gap.

The collapsible reel further preferably comprises a transverse flange adjacent a first end of the annulus, the flange radially extending past the outer circumferential surface of the annulus.

The collapsible reel further preferably comprises a second endcap removably attached to the second end of the annulus, the second endcap having a transverse flange adjacent the second end of the annulus, the flange radially extending past the outer circumferential surface of the annulus, and a shoulder disposed under the inner circumferential surface of the annulus, wherein the shoulder is adapted to maintain the annulus in the expanded state when engaged therewith, wherein at least a portion of the annulus contracts when one of the endcaps is removed therefrom, thereby reducing at least a portion of the gap.

In a preferred embodiment, both of the endcaps are removably attached to the annulus.

In another aspect, the present invention relates to a collapsible reel comprising: a resilient discontinuous annulus having an outer circumferential surface and an inner circumferential surface generally disposed about a longitudinal axis, first and second longitudinally spaced apart ends, and first and second edges defining a generally longitudinal discontinuity, wherein the inner and outer circumferential surfaces and ends are capable of being symmetrically disposed about the longitudinal axis when the annulus is in an expanded state, and wherein the first and second edges form a gap at the discontinuity when the annulus is in the expanded state; and a pair of endcaps spaced apart by the annulus and disposed at respective ends of the annulus, each endcap having a transverse flange adjacent a respective end of the annulus, the flange radially extending past the outer circumferential surface of the annulus, and a shoulder disposed under the inner circumferential surface of the annulus, wherein the shoulders of the opposing endcaps are adapted to maintain the annulus in the expanded state when engaged therewith, wherein at least one of the opposing endcaps is removably attached to the annulus, and wherein at least a portion of the annulus contracts when at least one of the opposing endcaps is removed therefrom, thereby reducing at least a portion of the gap.

In a preferred embodiment, both of the endcaps are removably attached to the annulus.

In another preferred embodiment, the collapsible reel of claim 5 wherein one of the endcaps is fixedly attached to the annulus.

In one embodiment, the collapsible reel further preferably comprises a fastener disposed on the inner circumferential surface such that the gap is capable of being prevented from either increasing or decreasing.

In another embodiment, the collapsible reel further preferably a fastener disposed on the inner circumferential surface such that the gap is capable of being prevented from both increasing and decreasing. In an alternate embodiment, the fastening device 44 is a turnbuckle.

Preferably, the gap is adjustable.

Preferably, at least one of the endcaps further comprises a plurality of shoulders for engaging the inner circumferential surface of the annulus.

In a preferred embodiment, the outer circumference of the annulus in the expanded state is between about 3 inches and about 20 inches. In another preferred embodiment, the outer circumference of the annulus in the expanded state is about 4 inches. In yet another preferred embodiment, the outer circumference of the annulus in the expanded state is about 14 inches.

In a preferred embodiment, the annulus is comprised of plastic. Preferably, the endcaps are comprised of plastic.

In yet another aspect, the present invention relates to a method of measuring an optical property of an optical waveguide fiber, the method comprising: providing the optical waveguide fiber under tension in a wound state on a first reel, unwinding the optical waveguide fiber; rewinding the optical waveguide fiber into a plurality of loops on a collapsible reel; collapsing the collapsible reel; measuring the optical property; and expanding the collapsible reel.

In still another aspect, the present invention relates to a tray for holding coilable elongated product, the tray comprising an outer top surface, a bottom surface, a first wall depending downwardly from the outer top surface to a bottom surface, and at least one raised protrusion disposed on the bottom surface, radially inwardly from the outer wall, wherein the at least one raised protrusion has a second wall spaced apart from the first wall, wherein the first wall, the bottom surface, and the second wall form an annular trough capable of receiving the coiled elongated product. Preferably, the at least one raised protrusion further comprises an upper surface and a third wall disposed radially inwardly from the second wall and depending downwardly from the upper surface to form an inner trough capable of receiving a portion of the coiled elongated product. The tray further preferably comprises a raised central portion disposed radially inwardly from the third wall, wherein the second wall and the third wall form an inner annular trough.

In still another aspect, the present invention relates to the combination of the tray and optical fiber. In one preferred embodiment, the optical fiber is multimode optical fiber.

In even yet another aspect, the present invention relates to a tray assembly for holding coilable elongated product, the tray assembly comprising a unitary tray having a top surface forming at least one annular trough capable of receiving the coiled elongated product and at least one deformable insert for removable placement into the at least one annular trough. The tray assembly further preferably comprises a cover attached to the top surface. The tray assembly may further preferably comprise at least one bulkhead disposed on the cover.

In another aspect, the present invention relates to the combination of the tray assembly and optical fiber. In one preferred embodiment, the optical fiber is multimode optical fiber.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is an isometric schematic view a preferred embodiment of a collapsible reel according to the present invention;

FIG. 2 is an elevational side view of the collapsible reel of FIG. 1, shown without endcaps;

FIG. 3 is a side view of an endcap of the collapsible reel of FIG. 1;

FIG. 4 is a front view of the endcap of FIG. 3;

FIG. 5 is an isometric closeup view of the latch device of the collapsible reel of FIG. 1;

FIG. 6 is an isometric schematic view of the reel of FIG. 1 without endcaps and with optical fiber wound around the annulus;

FIG. 7 is an exploded isometric view of a tray assembly according to the present invention; and

FIG. 8 is a schematic partial cross-sectional view of a preferred embodiment of a cover for a tray assembly, showing a bulkhead disposed within the cover and two connectorized fibers for insertion therein.

### DETAILED DESCRIPTION OF THE PREFERRED EMBODIMENTS

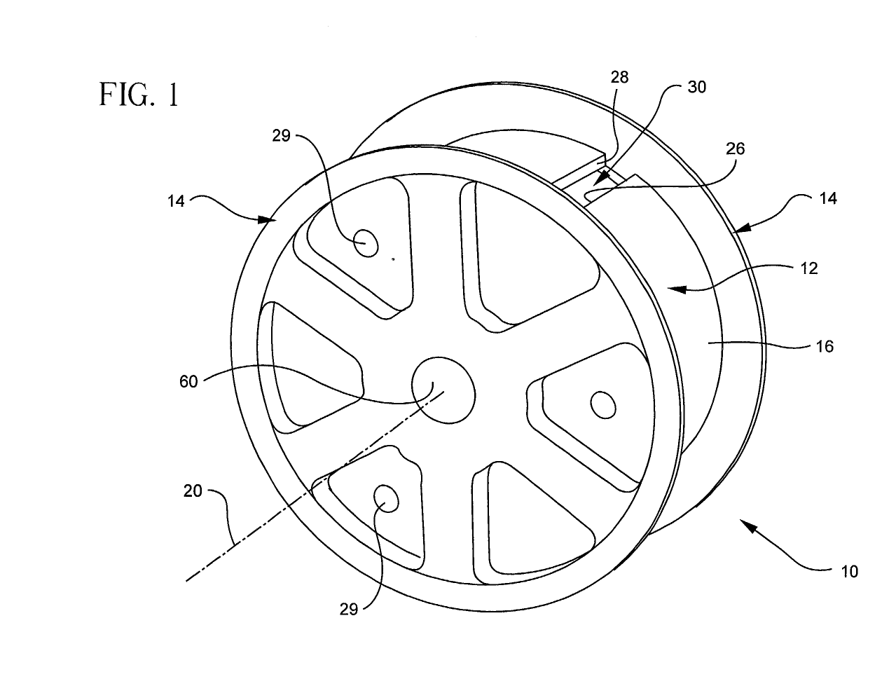

Reference will now be made in detail to the present preferred embodiments of the invention, examples of which are illustrated in the accompanying drawings. Wherever possible, the same reference numbers will be used throughout the drawings to refer to the same or like parts. An exemplary embodiment of the collapsible spool or reel 10 of the present invention is shown in FIG. 1, and is designated generally throughout by reference numeral 10.

Referring to FIG. 1, the present invention relates to a collapsible spool or reel 10 comprised of a resilient discontinuous annulus 12 and a pair of endcaps 14 spaced apart by the annulus 12 and disposed at respective ends of the annulus 12.

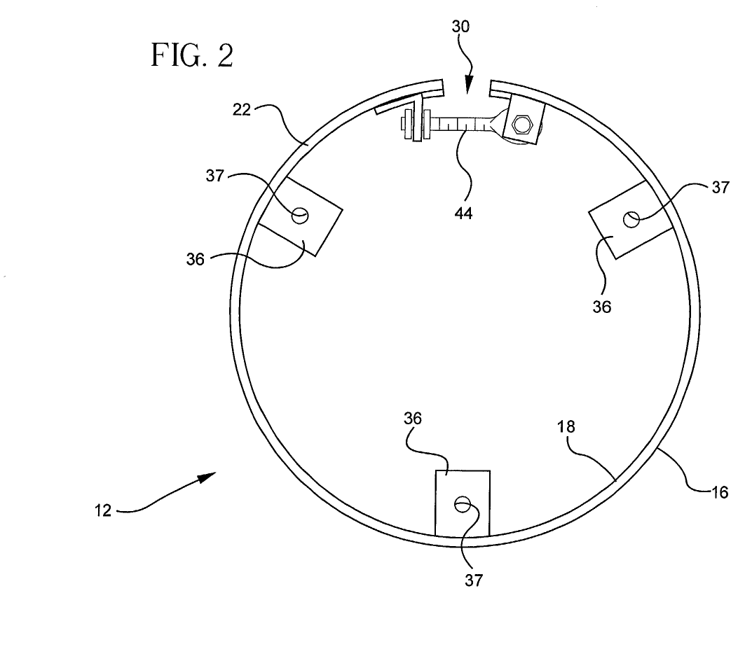

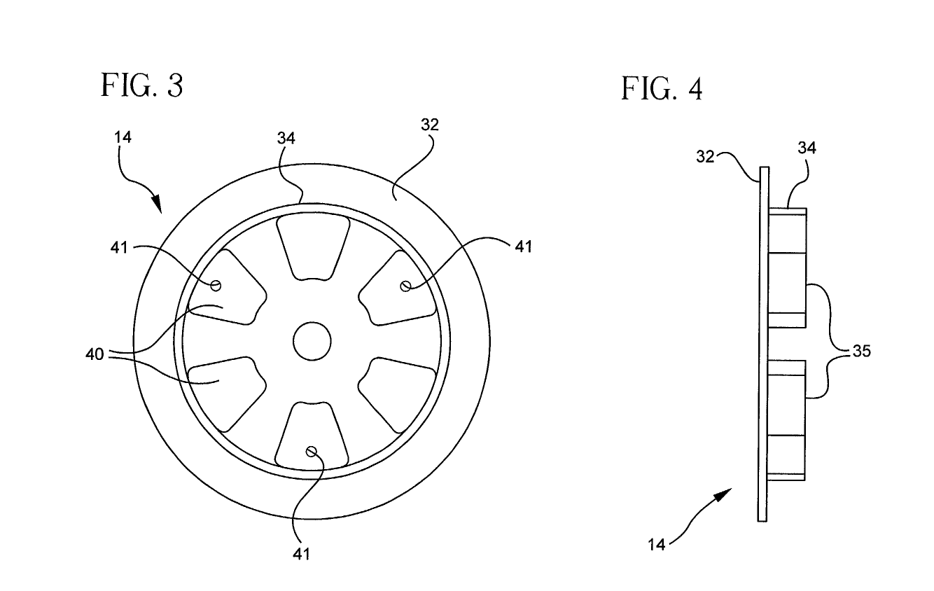

Referring to FIGS. 1 and 2, the annulus 12 has an outer circumferential surface 16 and an inner circumferential surface 18 generally disposed about a longitudinal axis 20. The annulus 12 also has first and second longitudinally spaced apart ends 22 and first and second edges, 26 and 28, which define a generally longitudinal discontinuity. Endcaps 14 are preferably attached to the annulus 12 by fasteners 29. Various fasteners 29 known in the art may be used. The outer and inner circumferential surfaces, 16 and 18, and ends 22 are capable of being symmetrically disposed about the longitudinal axis 20 when the annulus 12 is in an expanded state, as illustrated in FIG. 3. The first and second edges, 26 and 28, form a gap 30 at the discontinuity when the annulus 12 is in the expanded state.

Referring to FIGS. 1, 3 and 4, each endcap 14 is preferably removably attached to an end 22 of the annulus 12. Each endcap 14 preferably has a transverse flange 32 adjacent the first end 22 of the annulus 12 when attached to the annulus 12, the flange 32 radially extending past the outer circumferential surface 16 of the annulus 12. Each endcap 14 also preferably has a shoulder 34 disposed under the inner circumferential surface 18 of the annulus 12 when attached thereto. The shoulder 34 is preferably adapted to maintain the annulus 12 in the expanded state when engaged therewith.

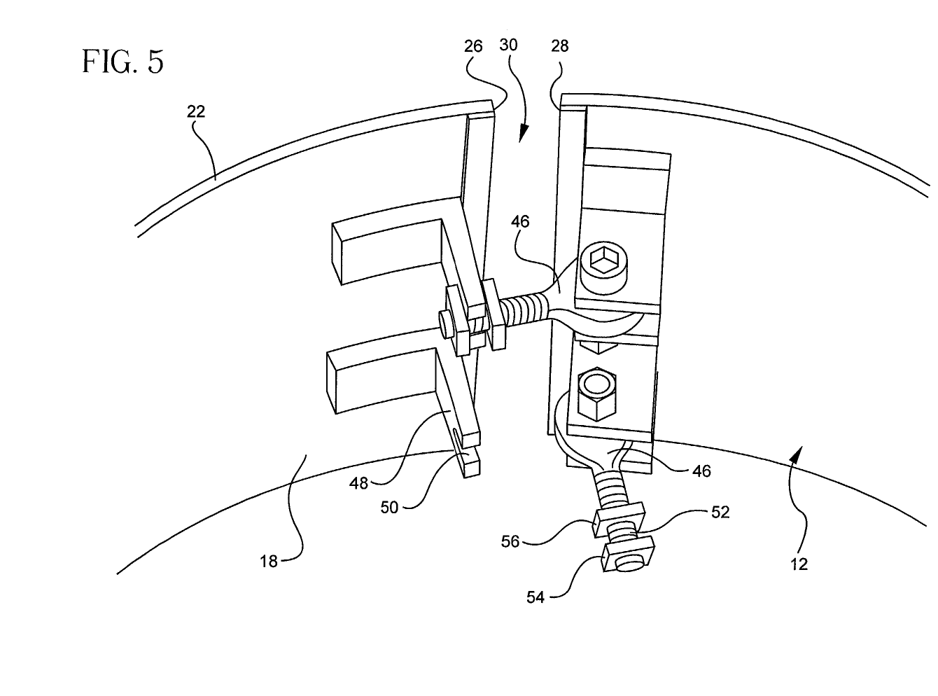

At least a portion of the annulus 12 contracts when an endcap 14 is removed therefrom, thereby reducing at least a portion of the gap 30. Preferably, both endcaps 14 are removed or removable to thereby reduce the gap 30 along its entire length, as seen in FIG. 5. In an alternative embodiment, one endcap 14 is removable, and another endcap is fixed to the annulus, or the annulus is formed with a fixed flange opposite the removable endcap to assist in retaining the coiled elongated product on the outer circumferential surface.

In one preferred embodiment, at least a portion of the first and second edges 26, 28 meet when not in the expanded state. In another preferred embodiment, at least a portion of the first and second edges 26, 28 overlap when not in the expanded state. The first and second edges 26, 28 may fully overlap when not in the expanded state.

Preferably, the discontinuity, and therefore the gap 30 in the expanded state, is parallel to the longitudinal axis 20. Alternatively, the discontinuity, and therefore the gap 30 in the expanded state, may form an angle with respect to the longitudinal axis 20.

Preferably, both of the endcaps 14 are removably attached to the annulus 12.

In one preferred embodiment, the endcaps 14 are removably attached to the annulus 12 with threaded fasteners. That is, the endcaps 14 are threadedly attached to the annulus 12.

As seen in FIG. 2, the annulus 12 comprises one or more mounts 36 capable of receiving a fastener 29 and preferably disposed on the inner circumferential surface 18 or on the edges 22. Mounts 36 preferably have one or more openings 39 adapted to receive a fastener. In one preferred embodiment, openings 39 are threaded and threaded fasteners 29 fix the endcap 14 to the one or more mounts 36, thereby removably attaching the endcap 14 to the annulus 12.

As seen in FIG. 3, each endcap 14 may preferably comprise a plurality of depressed portions 40. One or more of the depressed portions 40 preferably has an opening 41 adapted to allow fasteners 29 to pass therethrough. The depressed portions 40 may be advantageously disposed proximate or adjacent one or more mounts 36 disposed on the inner circumferential surface 18 of the annulus 12. Referring to FIG. 4, in a preferred embodiment one or more inner faces 35 of the depressed portions 40 contact mounts 36. Fasteners 29 may then be inserted through the depressed portions and into the mounts for securing the endcap 14 to the annulus 12.

A securing mechanism or fastening device 44 is preferably disposed on the inner circumferential surface 18 such that the gap 30 is preferably selectively capable of being prevented from either increasing or decreasing.

As seen in FIGS. 2 and 5, the fastening device 44 is comprised of a hinged latch 46 mounted proximate one end 22 and on the inner circumferential surface 18 of the annulus 12 and a mating latch receiver 48 is mounted proximate the other end 22 on the inner circumferential surface 18 of the annulus 12. The latch receiver 48 has a slot 50 with an open end facing radially inward toward the longitudinal axis 20. The latch 46 has a threaded distal end 52 capable of receiving one or more female threaded fasteners, such as nuts 54, 56. The distal end 52 of the latch 46 is capable of being placed within and removed from the slot 50.

As understood from FIG. 5, annulus 12 may be expanded, such as by pulling on edges 26, 28 and/or preferably additionally by pressing one or preferably both of the endcaps 14 into engagement with the annulus 12. Hinged latch 46 may then be pivoted into engagement with slot 50, wherein nuts 54, 56 are positioned upon the distal end 52 of the latch 46 such that one nut 54 is disposed on a distal side of the latch retriever 48 and the other nut 56 is disposed on a proximal side of the latch retriever 48. Then one or both nuts 54, 56 may be selectively adjusted such that the relative displacement between the edges 26, 28 can be selectively varied and further may be selectively locked in place, for example, by tightening both nuts 54, 56 against the latch receiver 48 when the desired displacement is attained. Thereafter, at least one of the nuts 54, 56 may be displaced away from the latch receiver 48, thereby creating relative travel between the latch receiver 48 and the latch 46. For example, if the proximal nut 56 is moved away from the latch receiver 48 while the annulus 12 is an expanded state, the gap 30 will decrease. The distal nut 54 may then be moved correspondingly closer to the latch receiver 48 and tightened thereto in order to effectively lock the position of the two edges 26, 28 with respect to one another, and consequently selectively fix the size of the gap 30. Thus, the fastening device 44, or latch 46 and latch receiver 48 disposed on the inner circumferential surface 18, can be adjustable such that the gap 30 is capable of being prevented from both increasing and decreasing.

In order to release the latch 46 and fully contract the annulus 12 from an expanded state, preferably the proximal nut 56, and preferably also the distal nut 54 if it was urging against the latch receiver 48, can be moved away from the latch receiver 48 and the latch 46 swung away from the latch receiver 48 and out of engagement with the slot 50. Thereafter, the gap 30 may partially or fully close in a collapsed state. At least a portion of the longitudinal edges 26, 28 may meet in a collapsed state. At least a portion of the longitudinal edges 26, 28 may overlap each other in a collapsed state.

At least one of the endcaps 14 may further comprises a plurality of shoulders for engaging the inner circumferential surface 18 of the annulus 12.

The endcaps 14 may further preferably comprise a central region defining a centerline aperture 60, which may be adapted, for example, to receive a spindle.

Preferably, the outer circumferential surface 16 of the annulus 12 has the shape of a circular cylinder in the expanded state so as to provide a hub of circular cross-section around which elongated product such as optical fiber may be wound.

Preferably, the diameter of the outer circumferential surface 16 of the annulus 12 in the expanded state is between about 3 inches and about 20 inches.

In one preferred embodiment, the diameter of the outer circumferential surface 16 of the annulus 12 in the expanded state is about 4 inches.

In another preferred embodiment, the diameter of the outer circumferential surface 16 of the annulus 12 in the expanded state is about 14 inches.

In still another embodiment, the diameter of the outer circumferential surface 16 of the annulus 12 in the expanded state is between about 12 inches and about 15 inches.

The outer circumference of the annulus 12 in the expanded state encompasses the discontinuity therein, and therefore may be referred to as an effective circumference of the annulus 12. Similarly, the diameter of the outer circumferential surface 16 of the annulus 12 in the expanded state may be referred to as an effective diameter of the annulus 12.

Preferably, the annulus 12 is comprised of a resilient material. One particularly preferred embodiment is an annulus 12 made from plastic, such as PVC.

Preferably the endcaps 14 are comprised of plastic. In one preferred embodiment, the endcaps 14 are comprised of polycarbonate. Polycarbonate or a similar plastic has been found to provide sufficient rigidity and strength to enable the endcap 14 to expand the annulus and to maintain the annulus in an expanded state.

Preferably the reel 10 is constructed to be statically balanced. Furthermore, the reel 10 is constructed to be dynamically balanced. Preferably, the reel 10 is constructed of lightweight material which is advantageous in winding operations as well as in transportation.

In one preferred embodiment, an optical fiber may be wound, either loosely or under tension, on the reel 10 of the present invention, then at least one endcap 14 may be removed from the annulus 12, and the diameter or effective diameter of the annulus 12, or at least part of the annulus 12, is reduced sufficiently to collapse the annulus 12 and reduce the tension in the optical fiber wound thereon. Optical characteristics or other characteristics of the fiber may then be made while the fiber is disposed on the reel, then the diameter or effective diameter of the annulus 12 may be increased and then locked into position so that the fiber may be stored or transported. Alternatively the fiber may be removed from the reel 10 to conduct measurements.

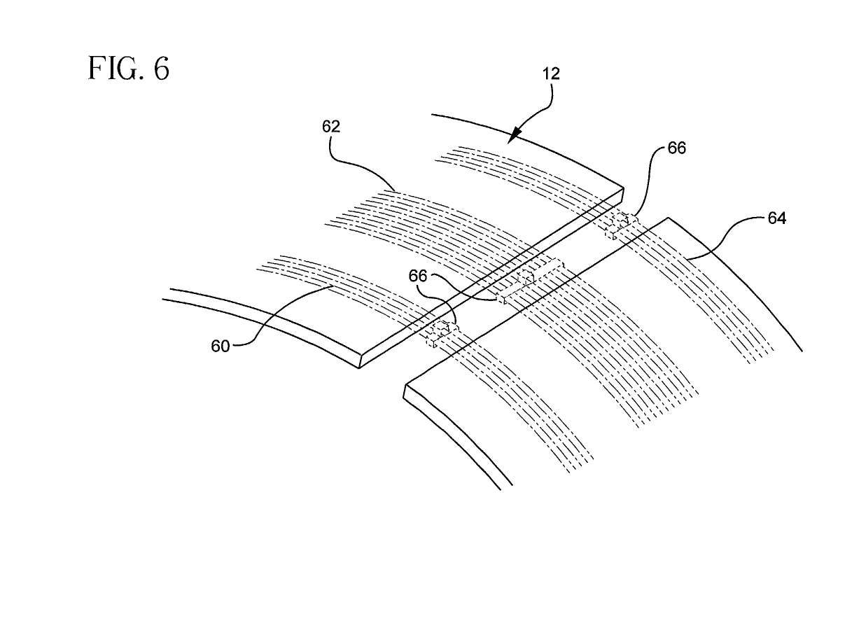

As shown schematically in FIG. 6, the optical fiber may be advantageously wound upon the inventive reel 10 such that the initial and final portions of the fiber are spaced apart on the surface of the annulus 12. Thus, for example, while the annulus 12 is the expanded state, the initial 60, middle 62, and/or final 64 portions of the wound fiber may be separately bound or secured, such as by tie(s) 66, so that when the fiber is removed from the annulus 12 in a collapsed state, the respective initial 60, middle 62, and/or final portions 64 may remain segregated from other portions of the loosely coiled loop of fiber, whether bond or unbound.

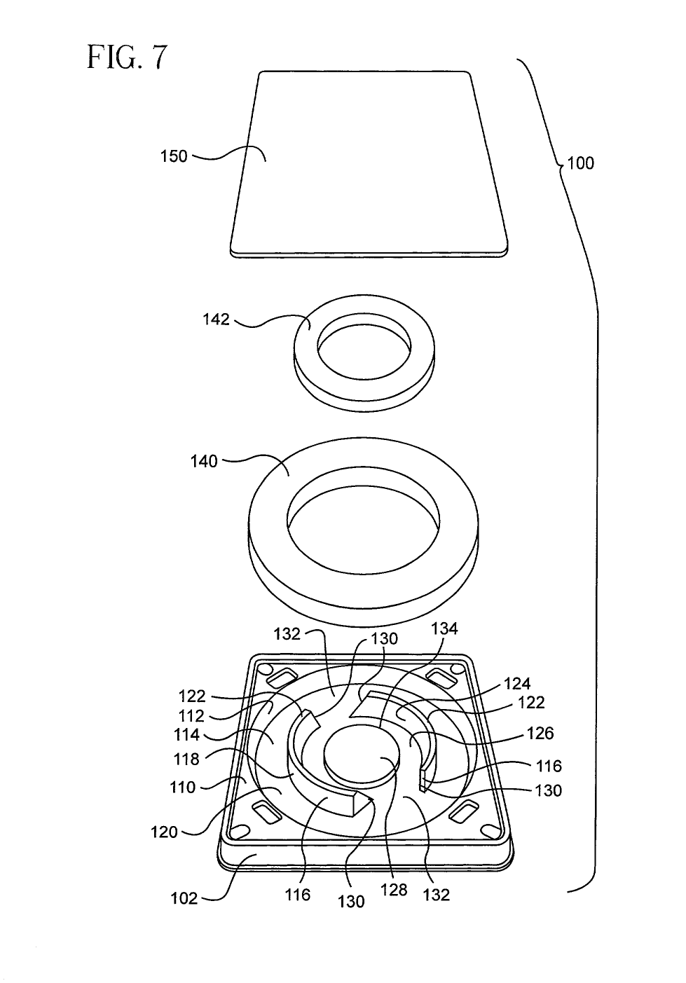

According to another aspect of the present invention, the loosely coiled optical fiber may then be placed into a holding tray assembly 100 comprised of a tray 102 as illustrated in FIG. 7.

The tray 102 preferably comprises an outer top surface 110, a first wall 112 depending downwardly from the outer top surface 110 to a bottom surface 114, and at least one raised protrusion 116 disposed on the bottom surface 114, radially inwardly from the first wall 112, wherein the at least one raised protrusion 116 has a second wall 118 spaced apart from the first wall 112, wherein the first wall 112, the bottom surface 114, and the second wall 118 form an annular trough 120 capable of receiving a coiled elongated product such as optical fiber. The at least one raised protrusion 116 preferably further comprises an upper surface 122 and a third wall 124 disposed radially inwardly from the second wall 118 and depending downwardly from the upper surface 122 to form an inner trough 126 capable of receiving a portion of the coiled elongated product. The tray 102 further preferably comprises a raised central portion 128 disposed radially inwardly from the third wall 124, wherein the second wall 118, the raised central portion 128, and the third wall 124 form an inner trough 126 in the form of an inner annular trough.

Preferably, the tray assembly 100 further comprises at least one insert for removable placement into at least one of the annular trough 120 or the inner trough 126. In a preferred embodiment, the insert is a deformable insert made of a resilient foam insert. The foam insert may be made from polyurethane, styrofoam, or other resilient or deformable plastic or other material known in the art. The insert preferably is adapted to snugly fit into a respective trough yet is removable therefrom. Generally, a resilient insert may be reusable, although a plastically deformable insert may be used which may be non-resuable.

The tray assembly 100 preferably further comprises a cover 150 attached to the outer top surface 110. Even more preferably, the cover 150 is removably attached to the outer top surface 110. The cover 150 may also be attached to one or more upper surfaces 122 of the raised protrusion(s) 116 in addition to or instead of attachment to the outer top surface 110.

In the preferred embodiment shown in FIG. 7, a tray assembly 100 includes a tray 102 comprised of an outer top surface 110, a first wall 112 depending downwardly from the outer top surface 110 to a bottom surface 114, and two raised protrusions 116 disposed on the bottom surface 114 and radially inwardly from the first wall 112, wherein the two raised protrusions 116 each have a second wall 118 spaced apart from the first wall 112, wherein the first wall 112, the bottom surface 114, and the second walls 118 form an annular trough 120 capable of receiving a coiled elongated product such as optical fiber. The two raised protrusions 116 each further comprise an upper surface 122 and a third wall 124 disposed radially inwardly from its respective second wall 118 and depending downwardly from the upper surface 122. The third walls 124 of the two raised protrusions 116 form an inner trough 126 capable of receiving a portion of the coiled elongated product. Each of the two raised protrusions 116 is preferably shaped in the form of a segment of circle, wherein the ends 130 of the protrusions 116 are spaced apart to form two openings 132 to the inner trough 126. The base of the inner trough 132 is formed by an inner bottom surface 134, which is preferably at or near the plane of the bottom surface 114 of the outer trough 120, although the inner bottom surface 134 may reside above or below the bottom surface 114 of the outer trough 120. The inner bottom surface 134 further preferably comprises a raised central portion 128 disposed radially inwardly from the third wall 124, wherein the inner trough 126 takes the form of an inner annular trough 126 defined by the inner bottom surface 134, the third wall 124 and the raised central portion 128.

Preferably the tray 102 is a unitary body. In the preferred embodiment, the tray 102 is a unipartite plastic body made by injection molding and/or stamping. Preferably the trays are adapted to be stackable upon one another.

The tray assembly 100 further comprises a first deformable insert 140 for removable placement into the outer annular trough 120 and a second deformable insert 142 for removable placement into the inner trough 126. The first and second deformable inserts 140, 142 are shown as having annular shapes. In a preferred embodiment, the deformable inserts are made from plastic foam.

The tray assembly 100 further comprises a cover 150 attached to the outer top surface 110 of the tray 102. Even more preferably, the cover 150 is removably attached to the outer top surface 110. The cover 150 may also be attached to one or more upper surfaces 122 of the raised protrusion(s) 116 in addition to or instead of attachment to the outer top surface 110. Preferably, the upper surfaces 122 and the outer top surface 110 are disposed on or about the same plane so as to receive a flat cover 150. The cover 150 may also be otherwise formed or molded to mate with the tray 102.

The cover 150 is preferably made of a lightweight material. In a preferred embodiment, the cover 150 is made from plastic. The cover 150 may be advantageously made from transparent plastic material to enable visual inspection of the contents of the tray assembly.

The outer annular trough 120 is preferably adapted to receive a coil of optical fiber, and at least one of the leads of the coil can preferably be placed in the inner annular trough 126. Preferably, both leads of the coil are placed in the inner annular trough 126. In one preferred embodiment, the fiber is loosely coiled when disposed in the tray 102.

The first deformable insert 140 may be placed over the coiled fiber disposed in the outer annular trough 120, wherein the insert 140 and the tray 102 are formed to provide a snug fit for the insert 140. The insert 140 is preferably deformed and generally stays in place when disposed within the outer annular trough 120.

The second deformable insert 142 may be placed over the leads of the coiled fiber disposed in the inner annular trough 126, wherein the insert 142 and the tray 102 are formed to provide a snug fit for the insert 142. The insert 142 is preferably deformed and generally preferably stays in place within the inner annular trough 126.

Thus, for example, a loose coil of fiber may be manually transported from room to room while disposed within the tray 102 under the foam inserts 140, 142 since under these conditions the tray assembly 100 and its contents would not be subject to strong forces to dislodge the fiber from the tray 102.

Furthermore, a cover 150 may be placed on top of the tray 102 and the inserts 140, 142 in order to more securely fix the coil and its leads into place as well as the inserts 140, 142. Preferably the cover 150 is removably attached to the tray 102. Preferably, the tray 102, foam inserts 140, 142 and cover 150 are adapted such that the cover 150 further comprises the foam inserts 140, 142 when attached to the tray 102 in addition to being compressed within the troughs 120, 126. The tray 102 may be preferably provided with one or more peripheral depressions 154 disposed at or near an outer periphery so that the cover 150 overlaps part of the depressions 154 when mounted on the tray 102. Thus, the user may conveniently pry the cover 150 away from the tray 102.

When the coiled fiber is disposed within the tray 102 and the cover 150 is fixed thereon, the fiber may be stored or shipped while generally maintaining its shape and minimizing changes in its condition.

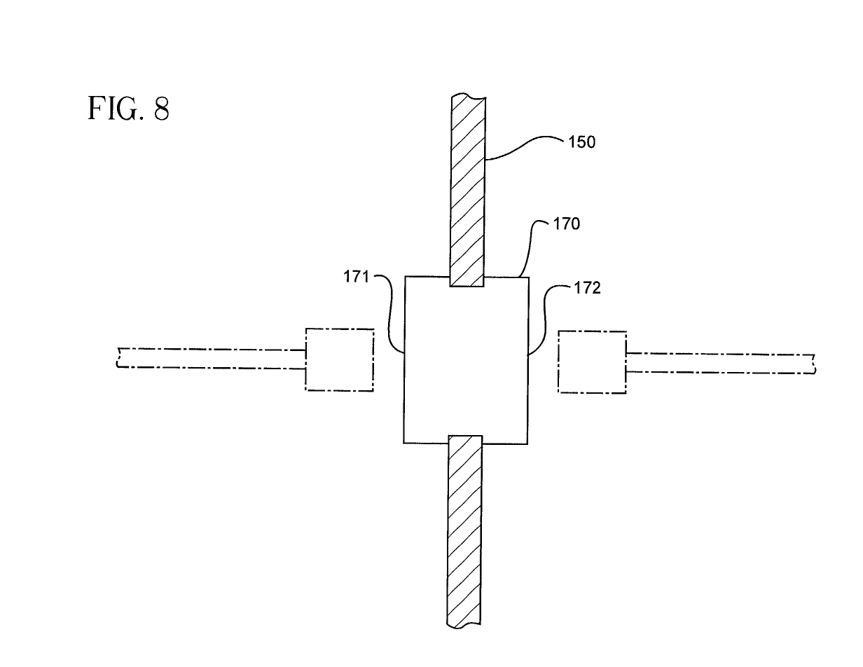

In one preferred embodiment, the assembly 100 comprises a cover 150 which is provided with one or more bulkheads or barrel connectors 170 capable of receiving the connectorized ends of two fibers, as seen in the schematic partial cross-sectional view in FIG. 8. Thus, the distal ends of the leads of the fiber disposed within the tray 102 may be provided with connectors, and the connectors inserted into an inner female portion on the inner side 171 of the bulkhead disposed on the inner side of the cover. A connector of another fiber or device may be connected to an outer female portion on the outer side 172 of the bulkhead disposed on the outer side of the cover 150. Thus, the coiled fiber disposed within the tray assembly may be tested or otherwise utilized without disassembling the tray assembly and removing the fiber therefrom. The fiber may thus be stored, tested, and/or transported all the while residing within the tray assembly 100. Preferably the tray assemblys are adapted to be stackable upon one another.

The tray assembly 100 of the present invention allows for storage of loosely coiled fiber without relying upon spools or reels. The fiber may be stored in relatively flat trays, thereby allowing flexibility and conservation of storage space. Furthermore, the fiber may be transported while disposed in the trays.

Both the collapsible reel 10 and the tray assembly 100 may be advantageously used with all manner of optical fiber. In a particularly preferred embodiment, the collapsible reel 10 and/or the tray assembly 100 are used with multimode fiber.

In another aspect, the present invention relates to a method of measuring an optical property of an optical waveguide fiber, the method comprising: providing the optical waveguide fiber under tension in a wound state on a first reel; unwinding the optical waveguide fiber; rewinding the optical waveguide fiber into a plurality of loops on a collapsible reel 10; collapsing the collapsible reel; measuring the optical property; and expanding the collapsible reel 10.

In yet another aspect, the present invention relates to a method of measuring an optical property of an optical waveguide fiber, the method comprising: providing the optical waveguide fiber under tension in a wound state on a first reel; unwinding the optical waveguide fiber; rewinding the optical waveguide fiber into a plurality of loops on a collapsible reel; collapsing the collapsible reel; removing the plurality of loops of the optical waveguide fiber from the collapsible reel in a substantially reduced state of tension; and measuring the optical property.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A collapsible reel comprising:
a resilient discontinuous annulus having an outer circumferential surface and an inner circumferential surface generally disposed about a longitudinal axis, first and second longitudinally spaced apart ends, and first and second edges defining a generally longitudinal discontinuity, wherein the inner and outer circumferential surfaces and ends are capable of being symmetrically disposed about the longitudinal axis when the annulus is in an expanded state, and wherein the first and second edges form a gap at the discontinuity when the annulus is in the expanded state; and
an endcap removably attached to the first end of the annulus, the endcap having:
a transverse flange adjacent the first end of the annulus, the flange radially extending past the outer circumferential surface of the annulus, and
a shoulder disposed under the inner circumferential surface of the annulus;
wherein the shoulder is adapted to maintain the annulus in the expanded state when engaged therewith;
wherein at least a portion of the annulus contracts when the endcap is removed therefrom, thereby reducing at least a portion of the gap.

2. The collapsible reel of claim 1 further comprising a transverse flange adjacent a first end of the annulus, the flange radially extending past the outer circumferential surface of the annulus.

3. The collapsible reel of claim 1 further comprising a second endcap removably attached to the second end of the annulus, the second endcap having:
a transverse flange adjacent the second end of the annulus, the flange radially extending past the outer circumferential surface of the annulus, and
a shoulder disposed under the inner circumferential surface of the annulus;
wherein the shoulder is adapted to maintain the annulus in the expanded state when engaged therewith;
wherein at least a portion of the annulus contracts when one of the endcaps is removed therefrom, thereby reducing at least a portion of the gap.

4. The collapsible reel of claim 1 wherein both of the endcaps are removably attached to the annulus.

5. A collapsible reel comprising:
a resilient discontinuous annulus having an outer circumferential surface and an inner circumferential surface generally disposed about a longitudinal axis, first and second longitudinally spaced apart ends, and first and second edges defining a generally longitudinal discontinuity, wherein the inner and outer circumferential surfaces and ends are capable of being symmetrically disposed about the longitudinal axis when the annulus is in an expanded state, and wherein the first and second edges form a gap at the discontinuity when the annulus is in the expanded state; and
a pair of endcaps spaced apart by the annulus and disposed at respective ends of the annulus, each endcap having:
a transverse flange adjacent a respective end of the annulus, the flange radially extending past the outer circumferential surface of the annulus, and
a shoulder disposed under the inner circumferential surface of the annulus;
wherein the shoulders of the opposing endcaps are adapted to maintain the annulus in the expanded state when engaged therewith;
wherein at least one of the opposing endcaps is removably attached to the annulus; and
wherein at least a portion of the annulus contracts when at least one of the opposing endcaps is removed therefrom, thereby reducing at least a portion of the gap.

6. The collapsible reel of claim 5 wherein both of the endcaps are removably attached to the annulus.

7. The collapsible reel of claim 5 wherein one of the endcaps is fixedly attached to the annulus.

8. The collapsible reel of claim 5 further comprising a fastener disposed on the inner circumferential surface such that the gap is capable of being prevented from either increasing or decreasing.

9. The collapsible reel of claim 5 further comprising a fastener disposed on the inner circumferential surface such that the gap is capable of being prevented from both increasing and decreasing.

10. The collapsible reel of claim 5 wherein the gap is adjustable.

11. The collapsible reel of claim 5 wherein at least one of the endcaps further comprises a plurality of shoulders for engaging the inner circumferential surface of the annulus.

12. The collapsible reel of claim 5 wherein the outer circumference of the annulus in the expanded state is between about 3 inches and about 20 inches.

13. The collapsible reel of claim 5 wherein the outer circumference of the annulus in the expanded state is about 4 inches.

14. The collapsible reel of claim 5 wherein the outer circumference of the annulus in the expanded state is about 14 inches.

15. The collapsible reel of claim 5 wherein the annulus is comprised of plastic.

16. The collapsible reel of claim 5 wherein the endcaps are comprised of plastic.

17. A method of measuring an optical property of an optical waveguide fiber, the method comprising:
providing the optical waveguide fiber under tension in a wound state on a first reel,
unwinding the optical waveguide fiber;
rewinding the optical waveguide fiber into a plurality of loops on a collapsible reel;
collapsing the collapsible reel;
measuring the optical property; and
expanding the collapsible reel.

18. A tray for holding coilable elongated product, the tray comprising:
an outer top surface, a bottom surface, a first wall depending downwardly from the outer top surface to a bottom surface, and at least one raised protrusion disposed on the bottom surface, radially inwardly from the outer wall,
wherein the at least one raised protrusion has a second wall spaced apart from the first wall, wherein the first wall, the bottom surface, and the second wall form an annular trough capable of receiving the coiled elongated product.

19. The tray of claim 18 wherein the at least one raised protrusion further comprises an upper surface and a third wall disposed radially inwardly from the second wall and depending downwardly from the upper surface to form an inner trough capable of receiving a portion of the coiled elongated product.

20. The tray of claim 19 further comprising a raised central portion disposed radially inwardly from the third wall, wherein the second wall and the third wall form an inner annular trough.

21. The combination of the tray of claim 18 and optical fiber.

22. The combination of claim 21 wherein the optical fiber is multimode optical fiber.

23. A tray assembly for holding coilable elongated product, the tray assembly comprising:
a unitary tray having a top surface forming at least one annular trough capable of receiving the coiled elongated product; and
at least one deformable insert for removable placement into the at least one annular trough.

24. The tray assembly of claim 23 further comprising a cover attached to the top surface.

25. The tray assembly of claim 24 further comprising at least one bulkhead disposed on the cover.

26. The combination of the tray assembly of claim 23 and optical fiber.

27. The combination of the tray assembly of claim 26 wherein the optical fiber is multimode optical fiber.
